(19) United States
(12) Patent Application Publication
(10) Pub. No.: US 2008/0134257 A1
(43) Pub. Date: Jun. 5, 2008

(54) Gleaning localized information via at least one satellite television broadcast

(75) Inventor: Christopher L. Oesterling, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/607,211

(22) Filed: Dec. 1, 2006

(51) Int. Cl. H04N 7/20

(52) U.S. Cl. 725/68

(57) ABSTRACT

A method of gleaning localized information via at least one satellite television broadcast includes receiving, at a call center, information from at least one information source, the information relating to at least one incident and at least one geographic location. A geographic region for the at least one incident is defined based upon the information. A channel that is local to the defined geographic region is identified via a satellite television broadcast. The identified local television channel is monitored to gather additional information regarding the incident.

### TECHNICAL FIELD

The present disclosure relates generally to localized information and, more specifically, to a method of gleaning localized information via satellite broadcast television.

### BACKGROUND

Satellite broadcast television service providers may provide local programming to subscribers, in addition to regional and/or national programming. As such, satellite broadcast television programming is capable of providing viewers with information related to incidents, such as emergencies, including those that are current and/or those that have recently occurred. In particular, local satellite broadcast television programming may provide relatively up-to-date information to viewers that are located proximate to an incident, or within an area affected by the incident.

When an incident occurs, a large amount of information related to the incident may be disseminated over satellite broadcast television, in addition to via any of a variety of other conduits (e.g., radio, non-satellite broadcast television, etc.). In some instances, it may be extremely time-consuming and/or difficult, if not essentially impossible, for a person to sift through the enormous amount of distributed information in order to discover desired information related to the incident.

Additionally, people located in mobile vehicles or away from such media conduits often desire and/or require current information regarding the status of a current or recent incident and its effects. Although many vehicles are equipped with advanced communication systems, being located in a mobile vehicle may further impede a person's ability to manually discover desired information related to the incident.

As such, it would be desirable to provide a method and system for gleaning localized information related to an incident via satellite broadcast television. Furthermore, it would be desirable to provide a method and system for transmitting the localized information to a user in a mobile vehicle.

### SUMMARY

An embodiment of a method of gleaning localized information via at least one satellite television broadcast includes receiving, at a call center, information from at least one information source. The information relates to at least one incident and at least one geographic location. A geographic region for the at least one incident is defined based upon the information. A channel that is local to the defined geographic region is identified via satellite television broadcast(s). The identified local television channel is monitored to gather additional information regarding the incident.

### BRIEF DESCRIPTION OF THE DRAWINGS

Features and advantages of embodiments of the present disclosure will become apparent by reference to the following detailed description and drawings, in which like reference numerals correspond to similar, though not necessarily identical components. For the sake of brevity, reference numerals or features having a previously described function may not necessarily be described in connection with other drawings in which they appear.

FIG. 1 is a schematic diagram depicting an embodiment of a system for gleaning localized information via at least one satellite television broadcast;

FIG. 2 is a schematic flow diagram depicting part of a system for gleaning localized information via at least one satellite television broadcast; and

FIG. 3 is a schematic flow diagram depicting an embodiment of a method for gleaning localized information via at least one satellite television broadcast.

### DETAILED DESCRIPTION OF THE EMBODIMENTS

Embodiment(s) of the system and method disclosed herein advantageously provide for improved collection of information related to an incident. Such information, which may be received from any combination of information sources, may be processed and utilized to identify television channels that are local to the geographic region of the incident. Such channels are available from at least one satellite television broadcast, which may be monitored to acquire more information related to the incident. Embodiment(s) of the method and system may also advantageously transmit notice of the incident and/or information related thereto to a telematics service subscriber.

It is to be understood that, as defined herein, a user may include a telematics service subscriber and/or vehicle operators/passengers.

An emergency situation or incident may include any of a multitude of natural or unnatural (e.g., human- or animal-caused) emergency situations. As non-limiting examples, the incident may include a hurricane, a tornado, a monsoon, a typhoon, a cyclone, a tsunami, a tidal wave, a volcanic eruption, a landslide, an avalanche, a flood, an earthquake, a fire, an explosion, a riot, an incident related to war and/or terrorism, or combinations thereof.

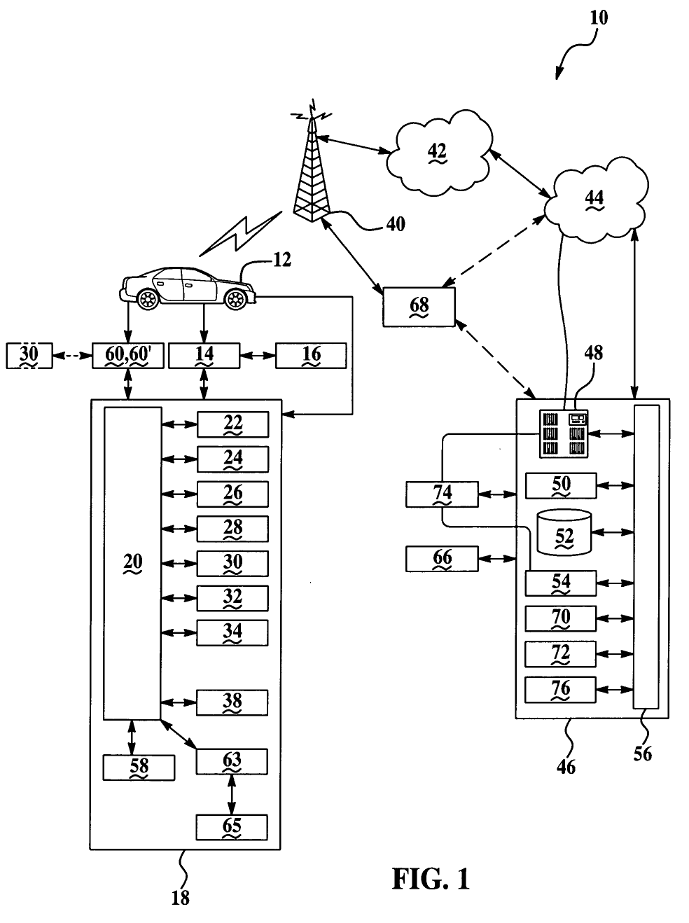

Referring now to FIG. 1, an embodiment of the system 10 includes a vehicle 12, a vehicle communications network 14, a telematics unit 18, a wireless communication system (including, but not limited to, one or more wireless carrier systems 40, one or more communication networks 42, and/or one or more land networks 44). In an embodiment, the wireless communication system is a two-way radio frequency communication system. In another embodiment, the wireless communication system also includes one or more call centers 46 and/or one or more Internet-enabled programs 68. In yet another embodiment, vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limiting example of which includes a Wide Area Network (WAN) transceiver), and/or combinations thereof.

Telematics unit 18 may include a processor 20 operatively coupled to a wireless modem 22, a location detection system 24 (a non-limiting example of which is a global positioning system (GPS)), an in-vehicle memory 26, a microphone 28, one or more speakers 30, an embedded or in-vehicle mobile phone 32, a real time clock (RTC) 34, a short-range wireless communication network 38 (e.g., a Bluetooth® unit), a user interface 63, and/or a user interface panel 65.

It is to be understood that the telematics unit 18 may be implemented without one or more of the above listed components, such as, for example, speakers 30. Additionally, it is to be understood that the speaker(s) 30 may be a component of the vehicle audio system 60 (which includes a receiver 60′), which may, in addition to radio broadcasts, accept audio and other signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limiting examples of the location detection system 24 include a Global Position Satellite receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

In-vehicle mobile phone 32 may be a cellular type phone, such as, for example an analog, digital, dual-mode, dual-band, multi-mode and/or multi-band cellular phone.

Also associated with processor 20 is the previously mentioned real time clock (RTC) 34, which provides accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g., call signals) between telematics unit 18, wireless carrier system 40, call center 46, and Internet-enabled program 68.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46 and/or to the Internet-enabled program 68. In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the call center 46 and/or the Internet enabled program 68.

Call center 46 may contain one or more data switches 48, one or more communication services managers 50, one or more communication services databases 52 containing subscriber profile records and/or subscriber information, one or more communication services advisors 54, one or more network systems 56, one or more aggregators 70, one or more geographic bounding engines 72, and/or one or more satellite channel selectors 76.

Information sources 74 are in communication with one or more components (e.g., the switch 48 and/or the service advisor(s) 54) of the call center 46. The information sources 74 provide information (e.g., pertaining to an incident, a geographic location, or the like) to the service advisor(s) 54 of the call center 46. Information sources 74 include, but are not limited to a news source, a weather source, a traffic source, a governmental source, an individual, a HAM radio operator, and combinations thereof. The information may be provided via one-way communications that are received at the call center 46 or via two-way communications between the information source 74 and the call center 46. In an embodiment, the information is provided in the form of audible data, textual data, graphical data, video data, audio data, binary data, and combinations thereof.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. In some embodiments, switch 48 also receives voice or data transmissions from information sources 74. Switch 48 receives data transmissions from, or sends data transmissions to one or more communication service managers 50 via one or more network systems 56.

Verbal communication from the vehicle 12 may take place via microphone 28 coupled to the in-vehicle or mobile phone 32 associated with the telematics unit 18. Caller utterances into the microphone 28 may be received at the call center 46, which may tokenize the utterance stream for further processing. In one embodiment, the tokenized utterances are placed in a subscriber information database 52 at the call center 46. It is to be understood that the call center 46 may receive other phone calls as well.

Call center 46 may contain one or more service advisors 54. In one embodiment, a service advisor 54 is human. In another embodiment, a service advisor 54 is an automaton. The service advisor(s) 54 may be located at the call center 46, or may be located remote from, but in communication with, the call center 46.

The call center 46 may also include a wireless service provider (e.g., Verizon Wireless®, Cingular®, Sprint®, etc.) and, in another embodiment, the call center 46 may include at least a portion of a wireless service provider. It is to be understood that, although a wireless service provider may be located at the call center 46, call center 46 is a separate and distinct entity from the service provider. In an embodiment, the wireless service provider may interact with the call center 46 to provide a service to a user.

The call center 46 may also be in operative communication with a transmitter 66. In an embodiment, the transmitter 66 is at least partially located within the call center 46. The signal sent via the transmitter 66 may be transmitted as a one-to-one or a one-to-many (i.e., broadcast) signal. The transmitter 66 may transmit a signal to at least one subscriber located within a predetermined distance from an incident. In an embodiment, the signal is transmitted to each telematics unit 18 associated with a subscriber-owned vehicle 12 currently located within, or having a last known address within the predetermined distance from the incident. The signal may be transmitted across the wireless carrier system 40, communication network 42, and/or land network 44. With respect to transmitting the signal, the predetermined distance may also be referred to herein as a “predetermined subscriber/incident distance”. In an embodiment, the transmitter 66 is configured to transmit more than one signal to at least one subscriber substantially simultaneously or sequentially. In another embodiment, the transmitter 66 is configured to transmit at least one signal to more than one subscriber substantially simultaneously or sequentially.

Contact information for one or more telematics services subscribers that are identified to receive the signal (e.g., vehicles 12 within the predetermined subscriber/incident distance) may be extracted from a centralized database (i.e., a subscriber database) prior to transmitting the signal. Contact information may include, for example, a garage or residential address, a telephone number, a facsimile number, and/or an e-mail address. In an embodiment, the contact information is located in the subscriber database, which is part of the communication services databases 52 located at, and maintained by the call center 46. In another embodiment, the contact information located in the databases 52 is accessible or extractable from a remote location via the Internet-enabled programs 68 (e.g., via a TCP/IP connection), wireless carrier system 40, the communication network 42, and/or the land network 44.

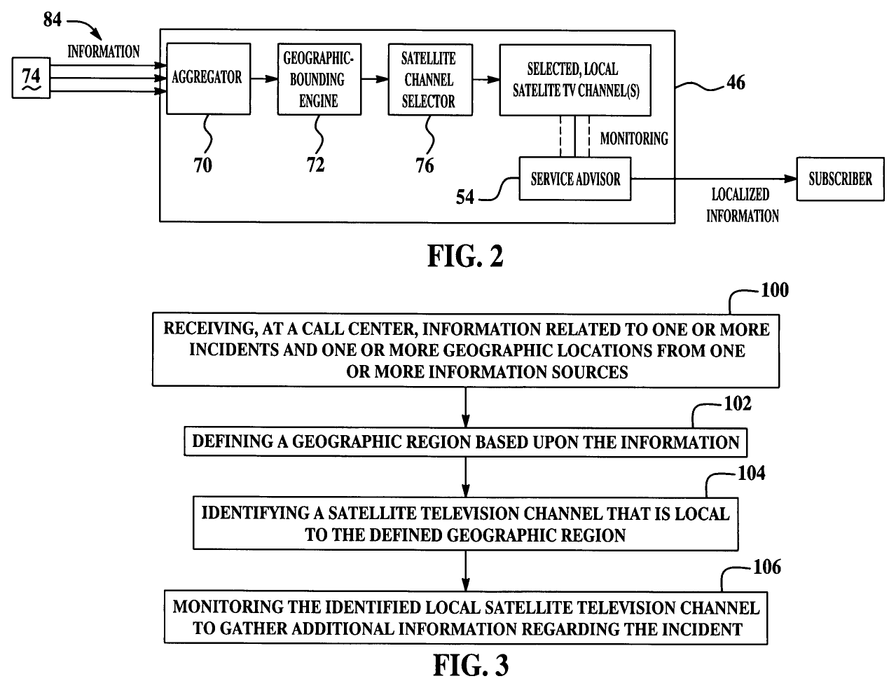

Referring now to FIGS. 1 and 2 together, the call center 46 includes, and is in operative communication with an aggregator 70. The aggregator 70 may be one or more automatons and/or humans. As shown in FIG. 2, the aggregator 70 receives information 84 from at least one information source 74. While one source 74 is shown in FIG. 2, it is to be understood that information may be received from a variety of different sources 74.

Non-limiting examples of suitable information sources 74 include television (including satellite), radio (including satellite), Internet web sites, facsimile, and/or personal communication devices. More specific non-limiting examples of such sources 74 include a news source (such as, for example, a national news radio or television station, and/or an Internet news source, such as CNN.com and REUTERS.com, etc.), a government source (such as, for example, a local government contact), a public or private company source (such as, for example, a contact at the American Red Cross®), a weather source (such as, for example, The Weather Channel®, the National Oceanic & Atmospheric Administration (NOAA) weather service), human input from an individual (including, for example, those transmitted via telephone, text messaging, and/or HAM radio), and/or a traffic source (such as, for example, streaming traffic data).

The information 84 provided by the information source(s) 74 generally relates to at least one incident and at least one geographic location. The information may include details of the incident and details of the areas affected by, or likely to be affected by the incident. The aggregator 70 may receive relatively large amounts of information pertaining to one or more incidents and one or more geographic locations from the information source(s) 74. From this information, the aggregator 70 determines the nature of the incident of interest and a general locale/geographic location of the incident of interest. It is to be understood that if multiple incidents occur substantially simultaneously in different geographic locations, one or a team of aggregators 70 may focus on information for one of the incidents, while another one or team of aggregators 70 may focus on information for another of the incidents.

The general geographic location may be defined by a geographic point and/or a discrete geographic area. In determining the general geographic location, the aggregator 70 consolidates the received information, and deduces therefrom a geographic location that includes areas that are reported as being affected or likely affected by the incident. As a non-limiting example, if a national television news program provides information regarding a tornado spotted in County X, then the general geographic location may be determined, by the aggregator 70, to be County X, and potentially a neighboring county located in the direction of travel of the tornado. In another example, if a power outage in portions of adjacent (or non-adjacent) cities A and B is reported by a HAM radio operator, then the general geographic location may be determined, by the aggregator 70, to be all of, or just those portions of cities A and B. In yet another example, if a chemical spill is reported at point C, definable, for instance by longitude and latitude coordinates, then the general geographic location may be determined, by the aggregator 70, to be point C, or a city, township, or county in which point C is located.

In an embodiment, the aggregator 70 is in operative communication with a geographic-bounding engine 72. As depicted in FIGS. 1 and 2, the geographic-bounding engine 72 may be located at least partially within the call center 46.

The geographic-bounding engine 72 receives the general geographic location of the incident from the aggregator 70. The geographic-bounding engine 72 uses the general geographic location to define a geographic region. The geographic region bounds, or circumscribes, the general geographic location. In an embodiment, the geographic-bounding engine 72 uses predetermined parameters (e.g., county, city, township, roads, surrounding vicinities thereof, and/or combinations thereof) to bind the general geographic location. A digital map database is used to bind the general geographic location. As a non-limiting example, if the general geographic location is the intersection of roads X and Y (which spans two different counties), the geographic-bounding engine may bind this location by the perimeters of the two counties. The bounding parameters may be more particular (e.g., at the intersection of roads X and Y, and the immediate vicinity), or they may be of greater scope (e.g., the counties in which X and Y are located, and a predetermined distance surrounding each of the counties). It is to be understood that the parameters selected for bounding may be determined, at least in part, by the size of the general location, the nature of the incident, and/or combinations thereof.

In another embodiment, defining the geographic region may include inputting numerous general geographic locations into a digital map database. Since large volumes of information may be received by the aggregator 70, the aggregator 70 may deduce multiple general geographic locations for the incident (e.g., latitude/longitude coordinate, a city, a county, etc). In such an embodiment, these locations are input into the digital map database, which is configured to (based on the selected parameters) recognize a concentration of the plurality of geographic locations, and graphically circumscribe the concentration, thereby grouping the plurality. In this embodiment, circumscribing the concentration may be accomplished, for example, by connecting various road segments to bound the locations; by inscribing by one or more county lines; by inscribing one or more city lines or municipality boundaries; and/or by combinations thereof. It is to be understood that any suitable digital map database and/or graphical software, and methods of using, may be utilized to define the geographic region.

The defined geographic region may be bound by actual city, township, county boundaries, or may be defined by some shape (irregular geometric shapes and/or regular geometric shapes) that encompasses the desirable area.

A satellite channel selector 76 is in operative communication with the geographic-bounding engine 72. It is to be understood that the satellite channel selector 76 may be operated by a human service advisor 54 or by an automaton service advisor 54. In an embodiment, the satellite channel selector 76 is at least partially located within the call center 46. The satellite channel selector 76 is used (e.g., by the service advisor 54) to identify a television channel (broadcast via a satellite television broadcast system) that is local to the defined geographic region (previously bound by the geographic-binding engine 72). Satellite television broadcast systems include national channels whose programming is the same nationwide, and local channels whose programming includes shows/broadcasts that are specific to a particular area. As non-limiting examples, the local television channel may be one or more network channels that broadcast local news programs to an area including the defined geographic location, or may be one or more channels that exclusively broadcast programs that are local to an area including the defined geographic region.

The satellite channel selector 76 includes databases/table/lists of channels/stations that are provided by one or more satellite television broadcast system(s). It is to be understood that the service advisors 54 of the call center 46 may have access to multiple satellite television broadcast systems, and thus the satellite channel selector 76 may include channels that are specific to the respective systems. Generally, the selector 76 is programmed to organize the channels (available from any number of systems) that offer local programming by the particular geographic area to which they are local. For example, a service advisor 54 at the call center 46 may query the selector 76 database(s) for a particular city. The selector 76 will then search for any channels that offer local programming in that particular city. Any results of the query are displayed or presented to the service advisor 54. It is to be understood that the results may include local channels that are broadcast via different systems (e.g., some local channels are available from DIRECTV® and other local channels are available from DISH NETWORK®).

The identified local satellite television channels may be monitored, for example, by at least one service advisor 54, to gather further information related to the incident. Such information may provide additional, more specific, localized information pertaining to the incident. This may be due, at least in part, to the fact that the information is provided via channels that are local to the area in which the incident is taking place or has taken place. The information may also pertain to those locations that are or are likely to be affected by the incident. The additional information may be filtered and/or consolidated as desired.

The service advisor(s) 54 may then contact telematics service subscribers who are located within, or whose recorded information identifies that they may be located within the defined geographic region. The service advisor(s) 54 generally contacts such subscribers to inform them of the incident and/or of any localized information received via the monitoring of the local channel(s). The service advisor(s) 54 may extract subscriber information from the previously described subscriber database. Such information may assist the service advisor(s) 54 in determining which subscribers are likely to be within an area affected by the incident.

As described briefly hereinabove, the subscriber database may contain information pertaining to the garage or residential address, a telephone number, fax number, email address, and/or combinations thereof. The call center 46 may approximate whether a subscriber's vehicle 12 is in an incident area by the vehicle's “garage address,” which is the residential address of the subscriber. For example, if a subscriber lived in New Orleans during Hurricane Katrina, then the confidence level is high that the subscriber is in the incident area.

In another example, each vehicle 12 in the incident area known by its garage address may be contacted by the call center 46 to determine the vehicle's actual current position. One method of accomplishing this is as follows. Each vehicle identification number (VIN) is known for each subscriber. The VIN may be used to send localized information to individual vehicles 12. The telematics unit 18 is aware of the VIN of the vehicle 12 in which the unit 18 is installed, and may compare the incoming VIN (from the call center 46) to its own. If the VINs match, then the localized information is accepted.

In yet a further example, the localized information may be broadcast, and the satellite radio receiver “listens” in the background in a dual receiver system (required for XM traffic data) that filters the information by city or region code. An algorithm may be present in the telematics unit 18 that can calculate a city or region code via the vehicle's current position. In a case where the vehicle does not have a GPS receiver, if the terrestrial repeater (i.e., ground stations that pick up and locally broadcast satellite radio content) broadcasts its ID or location code, that could be used to roughly determine the position of the vehicle.

The call center 46 may use the transmitter 66 or the wireless communication system to transmit the signal, which may include notice and/or other information pertaining to the incident, to the subscriber(s). As such, a service advisor 54 located at the call center 46 may initiate transmission of the signal. Generally, the service advisor 54 initiated communication upon becoming aware of the incident and after monitoring local channels for additional information pertaining to the incident. In an embodiment, the signal contains notice of the location of the incident, the area affected by the incident, and/or at least a portion of the information associated with the incident.

In another embodiment, the signal may be transmitted in response to a request for the signal from the subscriber. As a non-limiting example, the subscriber may request incident information via the in-vehicle telematics unit 18. A vehicle 12 user or passenger may initiate a request via an input device such as, for example, microphone 28 or in-vehicle user interface 63, whereby the signal is delivered from the call center 46 in response thereto.

A mobile vehicle 12 user may receive the notice in the form of a verbal notice (such as, for example, a telephone call and/or a radio-frequency communication system) or visual notice (such as, for example, via an in-vehicle user interface 65).

The satellite channel selector 76 may also include databases/lists/tables of radio channels (broadcast via satellite radio broadcast systems) that are local to the defined geographic region. Satellite radio systems include national channels whose programming is the same nationwide, and local channels whose programming includes shows/broadcasts that are specific to a particular geographic area (e.g., weather and traffic channels for a particular city). It is to be understood that the service advisors 54 of the call center 46 may have access to multiple satellite radio broadcast systems, and thus the satellite channel selector 76 may include channels that are specific to the respective systems. Generally, the selector 76 is programmed to organize the channels (available from any number of systems) that offer local programming by the particular geographic area to which they are local. For example, a service advisor 54 at the call center 46 may query the selector 76 radio database(s) for a particular city. The selector 76 will then search for any radio channels that offer local programming in that particular city. Any results of the query are displayed or presented to the service advisor 54. It is to be understood that the results may include local radio channels that are broadcast via different systems (e.g., some local channels are available from XM RADIO® and other local channels are available from SIRIUS RADIO®). Further, at least one of the service advisors 54 may monitor the satellite radio broadcast(s) to gather additional localized information pertaining to the incident. In an embodiment, the satellite radio broadcast(s) and the satellite television broadcast(s) are monitored (and information gathered therefrom) substantially simultaneously or sequentially.

Referring now to FIG. 3, an embodiment of a method for gleaning localized information via at least one satellite television broadcast is depicted. The method of FIG. 3 includes receiving, at a call center 46, information from at least one information source, where the information relates to at least one geographic location and at least one incident, as depicted at reference numeral 100. The method further includes defining a geographic region based upon the information, as depicted at reference numeral 102. At least one satellite television channel that is local to the defined geographic region is identified, as depicted at reference numeral 104. The method of FIG. 3 also includes monitoring the identified local satellite television channel(s) to gather additional information related to the incident, as depicted at reference numeral 106.

It is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct communication and indirect communication. As such, indirect communication includes communication between two components, having additional component(s) located therebetween.

While several embodiments have been described in detail, it will be apparent to those skilled in the art that the disclosed embodiments may be modified. Therefore, the foregoing description is to be considered exemplary rather than limiting.

1. A method of gleaning localized information via at least one satellite television broadcast, the method comprising:
receiving, at a call center, information from at least one information source, the information relating to at least one incident and at least one geographic location;
defining a geographic region for the at least one incident based upon the information;
identifying a satellite television channel that is local to the defined geographic region; and
monitoring the identified local satellite television channel to gather additional information regarding the incident.

2. The method of claim 1, further comprising:
identifying a satellite radio channel that is local to the defined geographic region; and
monitoring the identified local satellite radio channel to gather additional information regarding the incident.

3. The method of claim 1, further comprising transmitting a signal, including a notice of the incident, to at least one subscriber located within the defined geographic region.

4. The method of claim 3, further comprising, prior to transmitting the signal, extracting contact information for the at least one subscriber from a subscriber database.

5. The method of claim 4 wherein the contact information includes at least one of a garage address of a vehicle of the subscriber, a residential address, a telephone number, a facsimile number, an email address, or combinations thereof.

6. The method of claim 1 wherein the information is received by a human, an automaton, or combinations thereof.

7. The method of claim 1 wherein the at least one information source is selected from a news source, a weather source, a traffic source, a governmental source, an individual, a HAM radio operator, and combinations thereof.

8. The method of claim 1 wherein after the information is received, the method further comprises:
aggregating the information; and
determining a nature of the incident and a general geographic location of the incident based on the aggregated information.

9. The method of claim 8 wherein defining the geographic region includes bounding the general geographic location of the incident using predetermined parameters in a digital map database, wherein the predetermined parameters are selected from counties, cities, townships, roads, surrounding vicinities thereof, and combinations thereof.

10. The method of claim 1 wherein the information is received in a form selected from audible data, textual data, graphical data, video data, audio data, binary data, and combinations thereof.

11. The method of claim 1, further comprising:
initiating a request, from a subscriber to the call center, pertaining to the incident; and
responding to the request, wherein the information and the additional information assist the call center in responding to the request.

12. A system for gleaning localized information via at least one satellite television broadcast, the system comprising:
an aggregator configured to receive incident and geographic information from at least one information source, and to determine a nature of the incident and a general geographic location of the incident from the information;
a geographic-bounding engine in operative communication with the aggregator, the geographic-bounding engine configured to receive the general geographic location of the incident and to define a geographic region based upon the general geographic location; and
a satellite television broadcast system that is configured to output additional incident information via a channel that is local to the defined geographic region.

13. The system as defined in claim 12 wherein the aggregator, the geographic-bounding engine and the satellite television broadcast system each are operable by a service advisor located at a call center.

14. The system of claim 12, further comprising a satellite radio broadcast system configured to output additional incident information via a channel that is local to the defined geographic region.

15. The system of claim 12 wherein each of the aggregator, the geographic-bounding engine and the satellite television broadcast system is located within a call center, and wherein the system further comprises a wireless communication system selectively connecting the call center with at least one subscriber potentially located within the defined geographic area.

16. The system of claim 14, further comprising a subscriber database located within the call center, the subscriber database containing contact information for the at least one subscriber.

17. The system of claim 12 wherein the at least one information source is selected from a news source, a weather source, a traffic source, a governmental source, an individual, a HAM radio operator, and combinations thereof.

18. The system of claim 12 wherein the geographic-bounding engine is configured to bound the general geographic location of the incident using predetermined parameters selected from counties, cities, townships, roads, surrounding vicinities thereof, and combinations thereof.

19. The system of claim 12 wherein the aggregator is configured to receive the information in a form selected from audible data, textual data, graphical data, video data, audio data, binary data, and combinations thereof.
